(19) United States
(12) Patent Application Publication
(10) Pub. No.: US 2026/0048958 A1
(43) Pub. Date: Feb. 19, 2026

(54) Cutting Housing for Separating Sections of Roll Paper and Method for Cutting and Separating Sections of Roll Paper

(71) Applicant: Shenzhen Huafengqiwu Technology Co., Ltd, Guangdong (CN)

(72) Inventor: Danfeng LIU, Anhui (CN)

(73) Assignee: Shenzhen Huafengqiwu Technology Co., Ltd, Guangdong (CN)

(21) Appl. No.: 18/805,531

(22) Filed: Aug. 15, 2024

(51) Int. Cl. B65H 35/00; B26D 7/22

(52) U.S. Cl. CPC B65H 35/008; B26D 7/22

(57) ABSTRACT

The invention discloses a cutting housing for separating sections of roll paper and a method for cutting and separating sections of roll paper. The cutting housing for separating sections of roll paper comprises a shell with a roll paper channel running through the length of the shell from front to back, and two opposite sides surrounding the roll paper channel, wherein the roll paper channel can accommodate roll paper, with one end open for the roll paper to pass through; at least one side is equipped with a cutting channel and a cutting blade, and the cutting channel extends roughly along the length of the shell and connects the roll paper channel with the exterior of the shell; and the cutting blade is arranged in the cutting channel for manually separating sections of roll paper that enter the cutting channel.

### BACKGROUND OF THE INVENTION

### 1. Technical Field

The invention relates to the technical field of roll paper cutting, in particular to a cutting housing for separating sections of roll paper and a method for cutting and separating sections of roll paper.

### 2. Description of Related Art

Roll paper is a common household item, often placed on a roll holder in a paper towel box. To pull out a section of the roll paper, the roll is driven to rotate to allow paper to be pulled out, and then manually torn off. However, circumstances in which roll paper is used often do not allow for the use of both hands, and it is difficult to tear the paper with just one hand, thus resulting in inconvenience during use.

In the prior art, such as U.S. Pat. Nos. 2,229,961 and 4,989,769, a housing comprising a cutting blade is provided. The housing comprising a cutting blade, along with a protective device, is designed to laterally cut a section of roll paper from the housing and dispense roll paper on the housing. It is highly effective in cutting polymer sheet layers like roll paper. The housing also restricts unintentional contact with its cutting blade, thereby greatly reducing the possibility of damage to objects or injury to users handling equipment with blade installations.

While the aforementioned patents make it convenient to cut roll paper, they often do not deliver satisfactory results. The outdated methods of separating thin sheets of roll paper have been ineffective, as the slices are either jagged, torn, or curved, leading to a negative user experience. This also results in some degree of paper or time wastage. People have tried blades, knives, and sharper scissors, but these devices are not safe, posing risks to consumers, including children.

Therefore, a cutting housing is needed to separate sections of roll paper, with a blade installed on a lower part of a side of the housing. As paper is pulled out and passes through the blade, it can be cut by the blade edge. Furthermore, the housing is equipped with a protective design for the blade, preventing unintentional contact with its cutting edge.

### BRIEF SUMMARY OF THE INVENTION

The invention provides a cutting housing for separating sections of roll paper, comprising a shell with a roll paper channel running through the length of the shell from front to back, and two opposite sides surrounding the roll paper channel. The roll paper channel can accommodate roll paper, with one end open for the roll paper to pass through. At least one side is equipped with a cutting channel and a cutting blade, and the cutting channel extends roughly along the length of the shell and connects the roll paper channel with the exterior of the shell. The cutting blade is arranged in the cutting channel for manually separating sections of roll paper that enter the cutting channel.

The invention further provides a cutting housing for separating sections of roll paper, comprising a roughly arched shell with a roll paper channel running through the length of the shell from front to back, and two opposite sides surrounding the roll paper channel. The roll paper channel can accommodate roll paper and has a front end opening, a rear end opening and a lower end opening through which the roll paper can pass. At least one side is equipped with a cutting channel and a cutting blade, and the cutting channel extends roughly along the length of the shell and has two open ends to connect the roll paper channel with the exterior of the shell. The cutting blade is arranged in the cutting channel for manually separating sections of roll paper that enter the cutting channel.

The invention also provides a method for cutting and separating sections of roll paper, comprising:
providing a cutting housing for separating sections of roll paper, which comprises a shell with a roll paper channel running through the length of the shell from front to back, and two opposite sides surrounding the roll paper channel, wherein the roll paper channel can accommodate roll paper, with one end open for the roll paper to pass through; at least one side is equipped with a cutting channel and a cutting blade, and the cutting channel extends roughly along the length of the shell and connects the roll paper channel with the exterior of the shell; and the cutting blade is arranged in the cutting channel for manually separating sections of roll paper that enter the cutting channel.

The method comprises:
putting the roll paper in the roll paper channel of the shell;
extending a roll paper section at a free end of the roll paper to a certain length;
putting the roll paper section at the free end of the roll paper into the cutting channel in a lateral direction, so that the roll paper section passes through the cutting channel to the exterior of the shell;
moving the roll paper section at the free end of the roll paper in the extending direction of the cutting channel to engage with the blade, so as to manually separate the roll paper section entering the cutting channel from the roll paper; and
separating a required length of paper from the roll paper.

### BRIEF DESCRIPTION OF THE SEVERAL VIEWS OF THE DRAWINGS

In order to explain the technical scheme of the application more clearly, the drawings used in the embodiments will be briefly introduced below. Obviously, the drawings in the following description are only some embodiments of the application, and for those of ordinary skill in the field, other drawings can be obtained according to these drawings without paying creative labor.

FIG. 1 is a diagram of an overall structure of a preferred Embodiment I the invention;

FIG. 2 is a diagram of a local structure of a preferred Embodiment I the invention;

FIG. 3 is a structural diagram of a bracket in a preferred Embodiment I the invention;

FIG. 4 is a diagram of an overall structure of a preferred Embodiment II the invention;

FIG. 5 is a diagram of a local structure of a preferred Embodiment II the invention;

FIG. 6 is an explosive view of an overall structure of a preferred Embodiment II the invention; and

FIG. 7 is a structural diagram of an installation plate in a preferred Embodiment II the invention.

Included in the drawings:
shell (1000); side (1100); protective part (1110); installation column (1120); top portion (1200); bracket (1300); installation part (1310); slot (1311); guide part (1320); groove (1321); cutting blade (1322); inclined section (1340); cutting channel (2000).

### DETAILED DESCRIPTION OF THE INVENTION

The technical solution in the embodiments of the application will be described clearly and completely with reference to the drawings in the embodiments of the application. Obviously, the described embodiments are part of the embodiments of the application, not all of them. All other embodiments obtained by those of ordinary skill in the art based on the embodiments in this application without creative labor fall within the protection scope of this application.

Reference to an “embodiment” or “implementation” herein means that a particular feature, structure or characteristic described in connection with the embodiment or implementation may be included in at least one embodiment of the application. Appearance of the term in various parts in the specification does not necessarily refer to the same embodiment, nor is it a independent or alternative embodiment mutually exclusive of other embodiments. It is understood explicitly and implicitly by those having ordinary skill in the art that the embodiments described herein may be combined with other embodiments.

In this specification, for the sake of convenience, words indicating orientation or positional relationship such as “middle”, “upper”, “lower”, “front”, “rear”, “vertical”, “horizontal”, “top”, “bottom”, “inner” and “outer” are used to illustrate the positional relationship of constituent elements with reference to the attached drawings. These words are only for the convenience of describing this specification and simplifying the description, and do not indicate or imply that the devices or elements referred to must have a specific orientation, or be constructed and operated in a specific orientation, so they cannot be understood as limitations of this disclosure. The positional relationship of the constituent elements can be appropriately changed according to the direction of the described constituent elements. Therefore, the invention is not limited to the words and expressions described in the specification, and appropriate change can be made according to the situation.

### Embodiment I

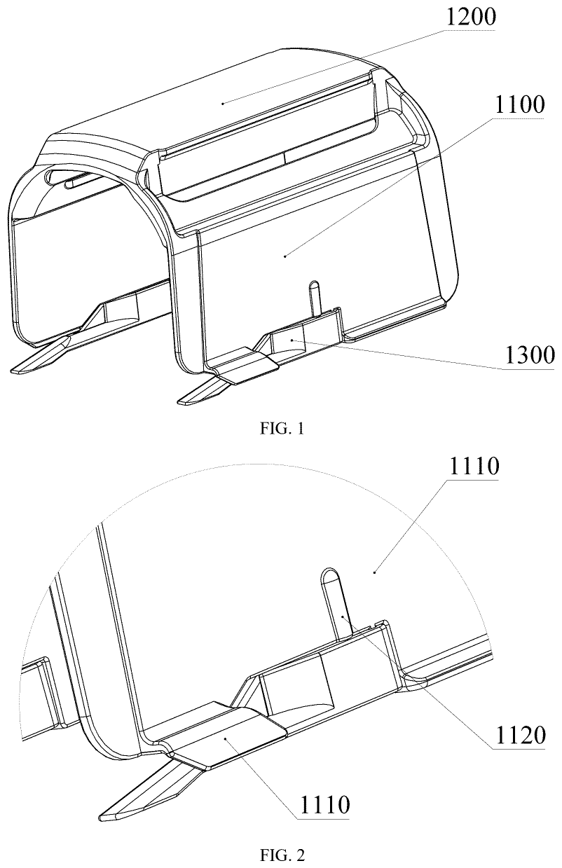

As shown in FIGS. 1-3, the invention provides a cutting housing for separating sections of roll paper, comprising a shell 1000 with a roll paper channel running through the length of the shell 1000 from front to back, and two opposite sides 1100 surrounding the roll paper channel. The roll paper channel can accommodate roll paper, with one end open for the roll paper to pass through. At least one side 1100 is equipped with a cutting channel 2000 and a cutting blade 1322, and the cutting channel 2000 extends roughly along the length of the shell 1000 and connects the roll paper channel with the exterior of the shell 1000. The cutting blade 1322 is arranged in the cutting channel 2000 for manually separating sections of roll paper that enter the cutting channel 2000.

The U-shaped/arched shell 1000 can enclose the cylindrical roll paper, and the blade is installed on a lower part of the side 1100 of the shell 1000, and is fixedly arranged on a bracket 1300. A gap is formed between the bracket 1300 and the shell 1000 to allow paper to be fed in. The paper passes through the gap to reach a blade edge, where it is cut by the blade edge.

In some embodiments, the shell 1000 is not limited to the U-shape/arch shape, and can be adjusted into a circular shape or other shapes suitable for enclosing the cylindrical roll paper according to the actual situation. Meanwhile, the material of the shell can also be adjusted according to the use environment and cost requirements, such as using different kinds of plastics, metals or composite materials.

In some embodiments, the roll paper channel can accommodate the roll paper and has a front end opening, a rear end opening and a lower end opening through which the roll paper can pass. The cutting channel 2000 extends roughly along the length of the shell 1000 and has two open ends to connect the roll paper channel with the exterior of the shell 1000.

The shell 1000 further comprises a top portion 1200 connecting the two sides 1100, and the top portion 1200 and the two sides 1100 form a substantially arch shape. The two sides 1100 are arranged in parallel, and there is a gap between the two sides 1100 through which the roll paper can pass. The two sides 1100 are each provided with a cutting channel 2000 and a cutting blade 1322, allowing users to cut the roll paper in two different directions.

In some embodiments, the specific position and installation mode of the blade can be replaced according to cutting efficiency and safety requirements. For example, the blade may be designed to be adjustable in height or angle to better adapt to paper of different thicknesses. The cutting channel 2000 extends roughly along the length of the shell 1000 from edges of the sides 1100 to form an opening and a tail end. Two sides of the cutting channel 2000 are open ends to connect the roll paper channel with the exterior of the shell 1000, and a roll paper section at a free end of the roll paper can pass through the roll paper channel from the open ends on both sides or enter the roll paper channel from the opening of the roll paper channel.

In some embodiments, the cutting channel 2000 and the roll paper channel are not limited to interacting through the open ends. According to the actual situation, other interactive ways may be added, such as setting auxiliary mechanisms like sliding rails, rollers or guide plates, to optimize the transmission of the free end of the roll paper in the channel and ensure the accuracy and smoothness of cutting.

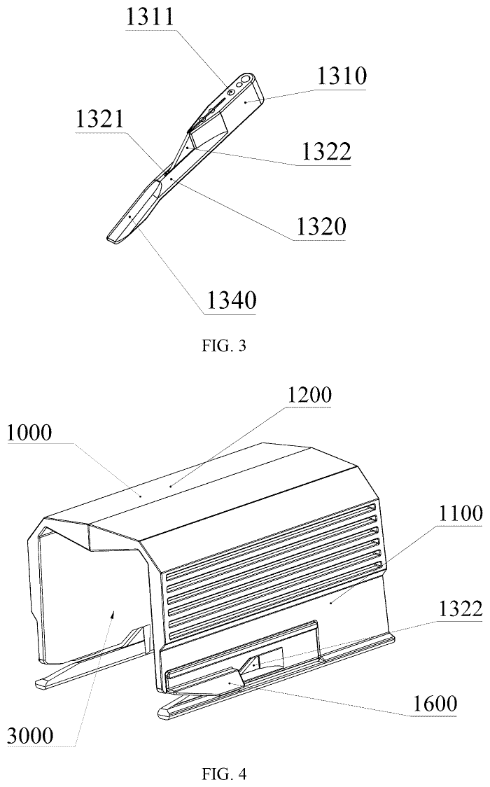

As shown in FIGS. 2 and 3, a bracket 1300 installed onto a lower edge of the side 1100 is further provided. The bracket 1300 comprises an installation part 1310 connected with the side 1100 and a guide part 1320 connected with the installation part 1310. The guide part 1320 extends outward from the installation part 1310 along the length of the shell 1000, a certain gap is reserved between the guide part 1320 and the side 1100 to form the cutting channel 2000, and the cutting blade 1322 is installed on the guide part 1320.

The installation part 1310 is responsible for fixing the bracket 1300 to the side 1100, which can be designed for different fixing mechanisms, such as screw fixing, snap connection, magnetic attachment, etc., depending on the convenience and firmness requirements of installation.

The specific type and characteristics of the cutting blade 1322 (such as material, cutting edge shape, sharpness, etc.) can be replaced or optimized according to the material, thickness and cutting efficiency requirements of an object to be cut. For example, for paper of different materials, different types of blades may be used to get the best cutting effect.

The guide part 1320 is provided with a groove 1321 near the tail end of the cutting channel 2000 for installing the cutting blade 1322. The cutting blade 1322 is installed in the groove 1321, and a sharp edge of the cutting blade 1322 faces the opening of the cutting channel 2000.

In some embodiments, according to specific design requirements, the position of the groove 1321 can be adjusted to optimize the cutting effect or meet other functional requirements. Meanwhile, the shape and size of the groove 1321 can also be designed according to the shape and installation requirements of the cutting blade.

The lower edge of the side 1100 is provided with an installation column 1120, and the installation part 1310 is provided with a slot 1311 for inserting the installation column 1120. The bracket 1300 is installed on the shell 1000 by inserting the installation column 1120 into the slot 1311. In some embodiments (not shown in the figure), the installation column 1120 and the slot 1311 can be arranged in reverse, that is, the installation column 1120 is disposed on the installation part 1310 of the bracket 1300, and the slot 1311 is disposed on the shell 1000. Alternatively, the bracket 1300 and the shell 1000 can be provided with other connection structures, such as guide rails matching elastic blocks, guide rails matching pins, and threaded connection structures, all of which can be used to install the bracket 1300 on the shell 1000, and some connection methods allow for the adjustment of the gap size of the cutting channel 2000.

By installing the cutting blade 1322 on the bracket 1300 and the bracket 1300 on the shell 1000, it is easy to replace or maintain the cutting blade 1322 after disassembling the bracket 1300, so that the service life of the whole shell 1000 is longer and the maintenance work is more convenient, and the user experience is improved.

A protective part 1110 is formed on the side 1100, and the protective part 1110 extends outward from the side 1100 to cover a side face of the cutting channel 2000, so as to limit the contact between users'fingers and the cutting blade 1322. The protective part 1110 is arranged on a face, away from the roll paper channel, of the side 1100. The protective part 1110 protrudes from the side 1100 and covers the side face of the cutting channel 2000. Users'fingers generally approach the shell 1000 from a side face or a front end of the shell 1000. Whether approaching the cutting channel 2000 from the side face or the front end of the shell 1000, especially when moving along the cutting channel 2000, the protective part 1110 is positioned in this direction and acts as a barrier. This barrier restricts users'fingers from getting close to the sharp edge of the cutting blade 1322, providing protection to prevent users from being cut by the blade during use, and ensuring a smooth user experience.

In some embodiments, the material of the protective part 1110 can be selected as required to ensure that it has sufficient strength and durability to withstand wear and impact in daily use. At the same time, the selection of materials should also consider its tactile sensation to users'fingers to avoid discomfort or injury to users.

One end, near the opening of the cutting channel 2000, of the guide part 1320 is provided with an inclined section 1340, which allows the roll paper section to easily enter the cutting channel 2000 from the opening of the cutting channel 2000. The inclined section 1340 makes it easier for the cutting channel 2000 to receive the roll paper section from the opening.

### Embodiment II

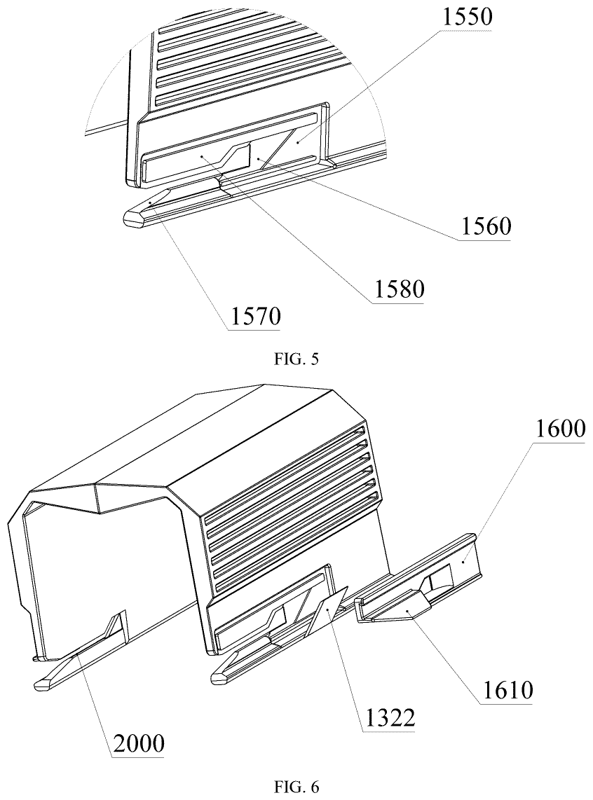

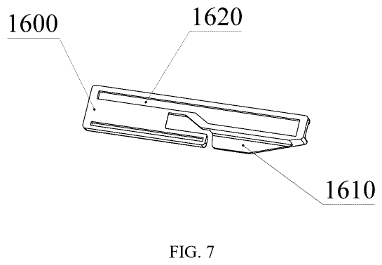

As shown in FIGS. 4-7, the invention further provides a cutting housing for separating sections of roll paper, comprising a shell 1000 with a roll paper channel running through the length of the shell 1000 from front to back, and two opposite sides 1100 surrounding the roll paper channel. The roll paper channel can accommodate roll paper, with one end open for the roll paper to pass through. At least one side 1100 is equipped with a cutting channel 2000 and a cutting blade 1322, and the cutting channel 2000 extends roughly along the length of the shell 1000 and connects the roll paper channel with the exterior of the shell 1000. The cutting blade 1322 is arranged in the cutting channel 2000 for manually separating sections of roll paper that enter the cutting channel 2000.

In some embodiments, the roll paper channel can accommodate the roll paper and has a front end opening, a rear end opening and a lower end opening through which the roll paper can pass. The cutting channel 2000 extends roughly along the length of the shell 1000 and has two open ends to connect the roll paper channel with the exterior of the shell 1000.

The shell 1000 further comprises a top portion 1200 connecting the two sides 1100, and the top portion 1200 and the two sides 1100 form a substantially arch shape. The two sides 1100 are arranged in parallel, and there is a gap between the two sides 1100 through which the roll paper can pass. The two sides 1100 are each provided with a cutting channel 2000 and a cutting blade 1322.

In some embodiments, the arrangement of the sides 1100 (such as non-parallel arrangement) and the size of the gap can be adjusted according to the size, material and transmission requirements of the roll paper.

The cutting channel 2000 extends roughly along the length of the shell 1000 from edges of the sides 1100 to form an opening and a tail end. Two sides of the cutting channel 2000 are open ends to connect the roll paper channel with the exterior of the shell 1000, and a roll paper section at a free end of the roll paper can pass through the roll paper channel from the open ends on both sides or enter the roll paper channel from the opening of the roll paper channel.

The difference from the previous embodiment is that:
as shown in FIGS. 4-7, a face, away from the roll paper channel, of the side 1100 is provided with an installation groove, and a blade groove is formed in the installation groove near the tail end of the cutting channel 2000. The installation groove is provided with an installation plate to press the cutting blade 1322 into the blade groove, and the sharp edge of the cutting blade 1322 is placed in the cutting channel 2000 and faces the opening of the cutting channel 2000.

In some embodiments, the specific positions and shapes of the installation groove and the blade groove can be adjusted according to the size, installation method and cutting effect of the cutting blade 1322. For example, the depth, width or length of the installation groove can be changed to adapt to cutting blades of different sizes; or the position and shape of the blade groove are adjusted to ensure that the cutting blade can be stably installed at the required position.

In some embodiments, the specific design of the installation plate (such as shape, size, material and installation method) can be adjusted as required. For example, installation plates in different shapes can be adopted to adapt to installation grooves in different shapes; or a stronger material is adopted to improve the durability of the installation plate. In addition, a detachable or adjustable installation plate may be designed to facilitate the replacement or adjustment of the cutting blade.

A protective plate is formed on the installation plate, and the protective plate extends outward from the installation plate to cover a side face of the cutting channel 2000, so as to limit the contact between users'fingers and the cutting blade 1322. The protective plate protrudes from the side 1100 and covers the side face of the cutting channel 2000. Users' fingers generally approach the shell 1000 from a side face or a front end of the shell 1000. Whether approaching the cutting channel 2000 from the side face or the front end of the shell 1000, especially when moving along the cutting channel 2000, the protective plate is positioned in this direction and acts as a barrier. This barrier restricts users' fingers from getting close to the sharp edge of the cutting blade 1322, providing protection to prevent users from being cut by the blade during use, and ensuring a smooth user experience.

The opening of the cutting channel 2000 is formed in an edge, near the front end of the shell 1000, of the side 1100. An inclined surface is arranged at the opening of the cutting channel 2000, which allows the roll paper section to easily enter the cutting channel 2000 from the opening of the cutting channel 2000. The inclined surface makes it easier for the cutting channel 2000 to receive the roll paper section from the opening.

In some embodiments, the specific design and angle of the inclined surface can be adjusted according to the material, thickness and transmission speed of paper. For example, the inclined angle, length or shape of the inclined surface can be changed to better adapt to the characteristics and transmission requirements of different types of paper.

In some embodiments, in order to further improve the smoothness and accuracy of paper entering the cutting channel, additional guiding or fixing mechanisms can be added at the opening. For example, a paper guide plate, a positioning clamp or a roller may be designed to help the paper enter the cutting channel accurately and keep it in the correct position.

The side 1100 is provided with a connecting rib in the installation groove, and the installation plate is provided with a connecting groove matching the connecting rib. In some embodiments (not shown in the figure), the connecting rib and the connecting groove can be arranged in reverse, that is, the connecting rib is arranged on the installation plate and the connecting groove is arranged on the shell 1000. Alternatively, the installation plate and the shell 1000 may be provided with other connecting structures that are not limited to a snap-fit with the installation groove, such as magnetic attraction structures and screw connection structures, all of which can be used to mount the installation plate onto the shell 1000 and press the cutting blade 1322 into the blade groove.

In this embodiment, the sharp edge of the cutting blade 1322 is obliquely arranged relative to the horizontal plane, and is oriented above the opening. By installing the cutting blade 1322 in the blade groove and the installation plate in the installation groove to press the cutting blade 1322, the cutting blade 1322 can be oriented obliquely below the opening of the cutting channel 2000, so that the cutting housing can be set with a relatively low height.

### Embodiment III

A method for cutting and separating sections of roll paper comprises:
providing a cutting housing for separating sections of roll paper, which comprises a shell 1000 with a roll paper channel running through the length of the shell 1000 from front to back, and two opposite sides 1100 surrounding the roll paper channel, wherein the roll paper channel can accommodate roll paper, with one end open for the roll paper to pass through; at least one side 1100 is equipped with a cutting channel 2000 and a cutting blade 1322, and the cutting channel 2000 extends roughly along the length of the shell 1000 and connects the roll paper channel with the exterior of the shell 1000; and the cutting blade 1322 is arranged in the cutting channel 2000 for manually separating sections of roll paper that enter the cutting channel 2000.

The method comprises:
putting the roll paper in the roll paper channel of the shell 1000 for storing and protecting the roll paper;
when necessary, extending a roll paper section at a free end of the roll paper to a certain length;
putting the roll paper section at the free end of the roll paper into the cutting channel 2000 in a lateral direction, so that the roll paper section passes through the cutting channel 2000 to the exterior of the shell 1000; here, the roll paper section can be kept in the cutting channel 2000 with a certain length extending outside the shell 1000 for easy access next time, and can also enter the cutting channel 2000 after being pulled out;
moving the roll paper section at the free end of the roll paper in the extending direction of the cutting channel 2000 to engage with the blade, so as to manually separate the roll paper section entering the cutting channel 2000 from the roll paper; and
separating a required length of paper from the roll paper.

The cutting of the roll paper is improved by the cutting blade 1322 so that the roll paper section does not have jagged, torn parts or curved cuts.

The technical means disclosed in the scheme of the invention are not limited to the technical means disclosed in the above embodiments, but also include technical schemes involving any combination of the above technical features. It should be noted that several improvements or embellishments made by those of ordinary skill in the art without departing from the principles of the invention should also be regarded as the scope of protection of the invention.

1. A cutting housing for separating sections of a roll of paper, comprising a shell comprising two opposite sidewalls forming a roll paper channel there between which extends through a length of the shell from front to back,, wherein the roll paper channel is configured to accommodate the roll of paper, an end of the roll paper channel is open to receive the roll of paper; at least one sidewall of the two opposite sidewalls of the shell defines a cutting channel and comprises a cutting blade, and the cutting channel extends in a direction of the length of the shell, the cutting channel is between the roll paper channel and the at least one sidewall; and the cutting blade is arranged in the cutting channel for manually separating sections of the roll of paper in the cutting channel, a face, away from the roll paper channel, of the at least one sidewall of the two opposite sidewalls is has an installation groove formed therein, and a blade groove to receive the cutting blade is formed in the installation groove at a tail end of the cutting channel, and the installation groove has an installation plate disposed therein to press the cutting blade into the blade groove, and a sharp edge of the cutting blade is in the cutting channel and faces an opening of the cutting channel.

2. The cutting housing for separating sections of roll paper according to claim 1, wherein the shell further comprises a top portion connecting the two sidewalls, and the top portion and the two sidewalls form a substantially arch shape.

3. The cutting housing for separating sections of roll paper according to claim 2, wherein the two sidewalls are arranged in parallel, and a gap is reserved between the two sidewalls through which the roll paper is able to pass.

4. The cutting housing for separating sections of roll paper according to claim 3, wherein the two sidewalls are each provided with a cutting channel and a cutting blade.

5. The cutting housing for separating sections of roll paper according to claim 1, wherein the cutting channel extends roughly along the length of the shell from edges of the sidewalls to form an opening and a tail end, and two sides of the cutting channel are open ends to connect the roll paper channel with the exterior of the shell.

6. The cutting housing for separating sections of roll paper according to claim 5, wherein a bracket installed onto a lower edge of the side is further provided, the bracket comprises an installation part connected with the side and a guide part connected with the installation part, the guide part extends outward from the installation part along the length of the shell, a certain gap is reserved between the guide part and the side to form the cutting channel, and the cutting blade is installed on the guide part.

7. The cutting housing for separating sections of roll paper according to claim 6, wherein the guide part is provided with a groove near the tail end of the cutting channel for installing the cutting blade, the cutting blade is installed in the groove, and a sharp edge of the cutting blade faces the opening of the cutting channel.

8. The cutting housing for separating sections of roll paper according to claim 6, wherein the lower edge of the side is provided with an installation column, and the installation part is provided with a slot for inserting the installation column.

9. The cutting housing for separating sections of roll paper according to claim 6, wherein a protective part is formed on the side, and the protective part extends outward from the side to cover a side face of the cutting channel, so as to limit the contact between users'fingers and the cutting blade.

10. The cutting housing for separating sections of roll paper according to claim 9, wherein the protective part is arranged on a face, away from the roll paper channel, of the side.

11. The cutting housing for separating sections of roll paper according to claim 6, wherein one end, near the opening of the cutting channel, of the guide part is provided with an inclined section, which allows the roll paper section to easily enter the cutting channel from the opening of the cutting channel.

12. (canceled)

13. The cutting housing according to claim 1, wherein a protective plate is formed on the installation plate, and the protective plate extends from the cutting groove orthogonally from the installation plate.

14. The cutting housing according to claim 1, wherein the opening of the cutting channel is formed on the at least one sidewall at the end of the roll paper channel, and at a front end of the shell.

15. The cutting housing according to claim 14, wherein an inclined surface is arranged at the opening of the cutting channel, the inclined surface facilitates the roll paper section to enter the cutting channel from the opening of the cutting channel.

16. The cutting housing according to claim 1, wherein the at least one sidewall of the two opposite sidewalls is further provided with a connecting rib in the installation groove, the connecting rib has a longitudinal extent extending along a longitudinal direction of the cutting channel and the installation plate is provided with a connecting groove matching the connecting rib.

17. A cutting housing for separating sections of a roll of paper, comprising an arch-shaped shell comprising two opposite sidewalls forming a roll paper channel there between which extends through a length of the shell from front to back, wherein the roll paper channel is configured to accommodate the roll of paper and has a front end opening, a rear end opening and a lower end opening, the front, the rear and the lower end openings cooperatively receive the roll of paper; at least one sidewall of the two opposite sidewalls of the shell defines a cutting channel and comprises a cutting blade, and the cutting channel extends in a direction of the length of the shell, and the cutting blade is arranged in the cutting channel for manually separating sections of the roll of paper in the cutting channel, a protective plate is aligned along and depends from an edge of the cutting channel, the protective plate extends outwardly from the at least one sidewall to cover a side face of the cutting channel to limit contact between a user's fingers and the cutting blade.

18. The cutting housing for separating sections of roll paper according to claim 17, wherein a bracket installed onto a lower edge of the side is further provided, the bracket comprises an installation part connected with the side and a guide part connected with the installation part, the guide part extends outward from the installation part along the length of the shell, a certain gap is reserved between the guide part and the side to form the cutting channel, and the cutting blade is installed on the guide part.

19. The cutting housing according to claim 17, wherein the opening of the cutting channel is formed on the at least one side of the cutting housing, at the end of the roll paper channel, and near at a front end of the shell, of the at least one sidewall of the two opposite sidewalls of the shell; a face, away from the roll paper channel, of the at least one sidewall of the two opposite sidewalls is provided with an installation groove, and a blade groove is formed in the installation groove near a tail end of the cutting channel; and the installation groove is provided with an installation plate to press the cutting blade into the blade groove, and a sharp edge of the cutting blade is placed in the cutting channel and faces the opening of the cutting channel.

20. A method to cut and separate sections of a roll of paper, the method comprising:
providing a cutting housing configured for separating sections of the roll of paper, wherein the cutting housing comprises a shell comprising two opposite sidewalls forming a roll paper channel there between which extends through a length of the shell from front to back, wherein the roll paper channel is configured to accommodate the roll of paper, one end of the roll paper channel is open to receive the roll of paper; at least one sidewall of the two opposite sidewalls of the shell defines a cutting channel and a cutting blade, and the cutting channel extends in a direction of the length of the shell, the cutting housing is between the roll paper channel and the at least one sidewall; and the cutting blade is arranged in the cutting channel, a face, away from the roll paper channel, of the at least one sidewall of the two opposite sidewalls is has an installation groove formed therein, and a blade groove to receive the blade is formed in the installation groove at a tail end of the cutting channel, and the installation groove has an installation plate disposed therein to press the cutting blade into the blade groove, and a sharp edge of the cutting blade is in the cutting channel and faces an opening of the cutting channel;
the method further comprising:
putting the roll of paper in the roll paper channel of the shell;
extending a section of the roll of paper by pulling a free end of the roll of paper to a certain length;
putting the section of the roll of paper into the cutting channel in a lateral direction, so that the section extends through the cutting channel, and the free end is at an exterior of the shell;
moving the roll of paper by pulling the free end in an extending direction of the cutting channel;
engaging a section of the roll of paper in the cutting channel with the blade; and
manually separating the section in the cutting channel from the roll of paper.

21. The cutting housing according to claim 1, wherein the at least one sidewall has parallel grooves extending longitudinally along the length direction of the shell.
